(19) United States
(12) Patent Application Publication
(10) Pub. No.: US 2016/0360304 A1
(43) Pub. Date: Dec. 8, 2016

(54) METHOD AND MEANS FOR REGULATING THE ELECTRICAL BIAS VOLTAGE AT THE MEASURING CAPACITOR OF A MEMS SENSOR ELEMENT

(71) Applicant: ROBERT BOSCH GMBH, Stuttgart (DE)

(72) Inventor: Thomas NORTHEMANN, Gerlingen (DE)

(21) Appl. No.: 15/116,619

(22) PCT Filed: Dec. 1, 2014
(86) PCT No.: PCT/EP2014/076056

§ 371 Date: Aug. 4, 2016

(30) Foreign Application Priority Data
Feb. 5, 2014 (DE) 10 2014 202 009.3

(51) Int. Cl. H04R 1/04; H04R 29/00

(52) U.S. Cl. CPC H04R 1/04; H04R 29/004; H04R 2201/003

(57) ABSTRACT

Measures for regulating the electrical bias voltage at the measuring capacitor of a MEMS sensor element are described. A base voltage is applied to the measuring capacitor and regulated in such a way that the potential difference between the two electrode sides of the measuring capacitor corresponds to the setpoint voltage. The base voltage is regulated in a low-voltage range.

### BACKGROUND INFORMATION

The present invention relates to a method and device for regulating the electrical bias voltage at the measuring capacitor of a MEMS sensor element, in which a base voltage is applied to the measuring capacitor, and in which this base voltage is subsequently regulated in such a way that the potential difference between the two electrode sides of the measuring capacitor corresponds to the setpoint voltage.

The regulation of the electrical bias voltage at the measuring or microphone capacitor of MEMS microphones is of particular significance. These generally include a sound pressure-sensitive diaphragm and a fixed counter-element. The diaphragm and the counter-element act as supports for the flat electrodes of the microphone capacitor, so that the changes of the distance between the diaphragm and the counter-element caused by sound pressure are detectable as capacitance fluctuations of the microphone capacitor. To increase the sensitivity of such MEMS microphones, a mechanical preload is applied to the diaphragm by applying a direct voltage to the microphone capacitor. This draws the diaphragm toward the counter-element electrostatically, the electrostatic force of the direct voltage counteracting the spring force of the diaphragm. This direct voltage may only be increased to the so-called pull-in point, at which the electrostatic force is equal to the spring force of the diaphragm. If the pull-in voltage is exceeded, the diaphragm snaps abruptly against the counter-element, as a result of which the microphone capacitor is short-circuited. Since the diaphragm at the pull-in point is in equilibrium of forces, each external force effect results in a diaphragm deflection, which is counteracted by no or only a very slight spring force. Consequently, the sensitivity of the diaphragm is highest at the pull-in point. If a MEMS microphone is to be operated in the range of maximum sensitivity, the electrical bias voltage at the microphone capacitor must be continuously monitored and regulated to the pull-in voltage. The pull-in voltage of MEMS microphones typically lies in the range of 5 V through 8 V. For regulating the electrical bias voltage of MEMS microphones, regulators are therefore used in practice, the output stage of which is able to regulate voltages of this magnitude.

### SUMMARY

The present invention relates to regulating the base voltage, which is applied to the measuring capacitor, in a low-voltage range. This makes it possible to omit a high-voltage output driver. Consequently, the electricity demand of the circuit is reduced as well as the ASIC area required for the circuit.

There are various possibilities for implementing such regulation of the base voltage at the measuring capacitor as well as for its circuitry-wise implementation.

In a first method variant, a predefined and non-variable base potential in the order of the setpoint voltage is applied to one electrode side of the measuring capacitor. A regulatable counter-potential, which is low compared to the base potential, is applied to the other electrode side of the measuring capacitor. This counter-potential is then regulated in such a way that the potential difference at the measuring capacitor corresponds to the setpoint voltage.

This first method variant may be implemented simply in analog circuitry using standard transistors. In one preferred specific embodiment, the means for regulating the electrical bias voltage at the measuring capacitor of a MEMS sensor element include in this case a first voltage source, which delivers a voltage in the order of the setpoint voltage and is connected to the first electrode side of the measuring capacitor as a predefined base potential n₁, a second voltage source, which delivers a voltage which is low in comparison to this and is connected to the other second electrode side of the measuring capacitor as counter-potential n₂, an operational amplifier A, the inverting input of which is connected to the second electrode side of the measuring capacitor and whose output is fed back to its inverting input via a defined capacitance Cᵢₙₜ, and a regulator connected downstream from the output of operational amplifier A, the second input of the regulator being connected to the first voltage source as reference voltage n₁, and whose output is fed back to the non-inverting input of operational amplifier A. In this way, counter-potential n₂ present at the inverting input of operational amplifier A is regulated on the second electrode side of the measuring capacitor via the output signal of the regulator.

Very different regulators may be used in this specific embodiment. However, an analog PI controller having a processing logic connected upstream proves to be particularly suitable. Such a PI controller includes at least one operational amplifier A_{PI}, which is fed back via a defined capacitance C₁ and a resistor R2, and a resistor R1 is connected upstream of its inverting input.

Another method variant for the regulation of the base voltage at the measuring capacitor according to the present invention provides for determining the difference between the capacitance of the measuring capacitor and a reference capacitance, the reference capacitance corresponding to the capacitance of the measuring capacitor when the setpoint voltage is applied. The base voltage applied to the measuring capacitor is subsequently regulated as a function of the determined capacitance difference.

This second method variant may advantageously be implemented simply with the aid of circuit means for digitizing the output signal. Thus, in a preferred circuitry-wise implementation of this method variant, the means for regulating the electrical bias voltage at the measuring capacitor include a voltage source, which is used as a voltage supply for a Wheatstone bridge. In this Wheatstone bridge, the measuring capacitor is interconnected with a reference capacitance C_{ref} and two additional capacitances C₁ and C₂, and specifically in such a way that the output signal of the Wheatstone bridge corresponds to the deviation of the potential difference at the measuring capacitor from the setpoint voltage. The output signal of the Wheatstone bridge is supplied to an operational amplifier A, downstream from which are connected a filter and a quantizer. The output signal of the quantizer is fed back to the Wheatstone bridge, so that the potential difference at the measuring capacitor is regulated via the bit stream of the quantizer.

In terms of circuitry, it is in particular simple if reference capacitance C_{ref} corresponds to the capacitance of the measuring capacitor when the setpoint voltage is applied and the two capacitances C₁ and C₂ are essentially identical.

The regulation according to the present invention may be based on an arbitrary setpoint voltage. The setting or regulation of the pull-in voltage at the measuring capacitor of a MEMS sensor element represents only one particularly advantageous application of the measures according to the present invention.

These may be used in any stress-sensitive capacitive sensor element, even if they prove to be advantageous in particular in connection with MEMS microphones.

### BRIEF DESCRIPTION OF THE DRAWINGS

As discussed above, there are various options for developing and refining the present invention in an advantageous manner. For this purpose, reference is made to the following description of two exemplary embodiments of the present invention based on the figures.

FIG. 1 shows the circuitry-wise design of a MEMS microphone including a first circuitry variant for regulating the electrical bias voltage at microphone capacitor C_{MIC}.

FIG. 2 shows the circuit diagram of a regulator 10 for the circuitry variant shown in FIG. 1.

FIG. 3 shows the schematic design of a MEMS microphone including a second circuitry variant for regulating the electrical bias voltage at microphone capacitor C_{MIC}.

### DETAILED DESCRIPTION OF EXAMPLE EMBODIMENTS

The exemplary embodiments described below relate in each case to a MEMS microphone including one microphone capacitor C_{MIC} for signal detection, an electrical bias voltage being applied to it for increasing the microphone sensitivity. This bias voltage is intended to be regulated to the pull-in voltage of the MEMS microphone element. For that purpose, a base voltage is applied to microphone capacitor C_{MIC} in both exemplary embodiments and regulated in such a way that the potential difference between the two electrode sides of microphone capacitor C_{MIC} corresponds to the pull-in voltage. According to the present invention, this regulation of the base voltage is implemented in the low-voltage range.

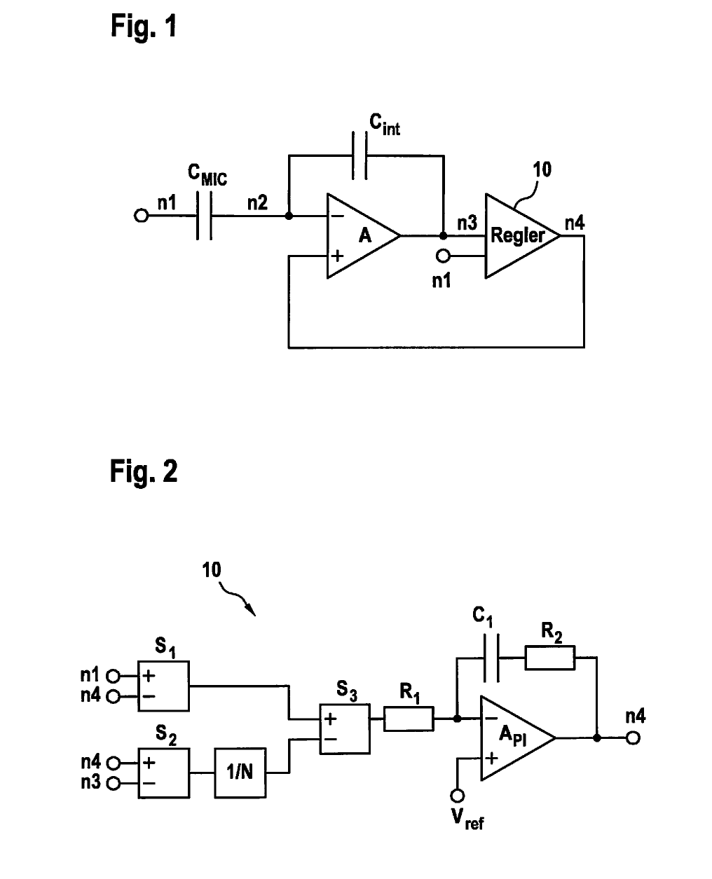

In the first exemplary embodiment shown in FIG. 1, the base voltage at microphone capacitor C_{MIC} is implemented with the aid of two voltage sources, each of which is connected to one electrode side of microphone capacitor C_{MIC}. The one voltage source delivers a voltage in the order of the setpoint voltage, i.e., the pull-in voltage, and is connected to one electrode side of microphone capacitor C_{MIC} as a predefined non-variable base potential n1. The other voltage source delivers a voltage which is low in comparison to this and is connected to the other electrode side of microphone capacitor C_{MIC} as counter-potential n2. The base voltage at microphone capacitor C_{MIC} results as the difference between base potential and counter-potential (n1−n2). At least base potential n1 is applied in the form of a modulation voltage. This may be, for example, a square-wave voltage, which may be implemented simply using two voltages and one selection switch.

In the specific embodiment of the present invention described here, base voltage (n1−n2) is regulated to the pull-in voltage, in that the first electrode side of microphone capacitor C_{MIC} is held at high base potential n1, while low counter-potential n2 on the second electrode side of microphone capacitor C_{MIC} is regulated accordingly. In MEMS microphones, the pull-in voltage normally lies in the range of 5 V through 8 V. Voltage n1 applied on the first electrode side must be accordingly high.

In the exemplary embodiment represented here, the regulation of lower counter-potential n2 takes place with the aid of an operational amplifier A used as a charge integrator and a regulator 10, the circuitry-wise integration of which is explained in greater detail in connection with FIG. 2.

The second electrode side of microphone capacitor C_{MIC} is connected to the inverting input of operational amplifier A, so that counter-potential n2 is thus applied here. Output n3 of operational amplifier A is on the one hand fed back to its inverting input via a defined integration capacitance Cᵢₙₜ. On the other hand, output n3 of operational amplifier A is supplied to one input of regulator 10. The second input of regulator 10 is connected to the first voltage source as reference voltage. Fixed base potential n1 is thus present at this input, the first electrode side of microphone capacitor C_{MIC} being held on this base potential. Output n4 of regulator 10 is fed back to the non-inverting input of operational amplifier A.

Since the difference of the inputs of operational amplifier A is regulated to zero, the inverting input does not follow the non-inverting input. In this way, counter-potential n2 on the second electrode side of microphone capacitor C_{MIC} may be controlled via output signal n4 of regulator 10 and consequently also the base voltage (n1−n2) present at microphone capacitor C_{MIC}.

FIG. 2 represents an embodiment variant for regulator 10. The core element is a PI controller made up of an amplifier API, a capacitance C₁ and two resistors R1 and R2. Resistor R1 is connected upstream from the inverting input of amplifier API.

The non-inverting input of amplifier API is connected to a reference potential V_{ref}, which corresponds to 0 V in the exemplary embodiment represented here. Output n4 of amplifier API is fed back to its inverting input via resistor R2 and capacitance C1. Three subtractors S₁, S₂, S₃ and one factor N or 1/N are connected upstream from resistor R1, so that a zero is output at the output of subtractor S₃, when the following condition is met: C_{MIC}=N·Cᵢₙₜ·C_{MIC} denotes here the capacitance of the microphone capacitor. Its capacitance at the pull-in point may be determined simply by reducing the base distance of the capacitor electrodes to 2/3 in the capacity calculation. Since integration capacitance Cᵢₙₜ of operational amplifier A is known, factor N may be calculated simply and implemented accordingly in the circuitry.

Amplifier API subsequently delivers an output voltage N4, which is used to set counter-potential n2 on one electrode side of microphone capacitor C_{MIC} in such a way that the base voltage (n1−n2) corresponds to the pull-in voltage of microphone capacitor C_{MIC}.

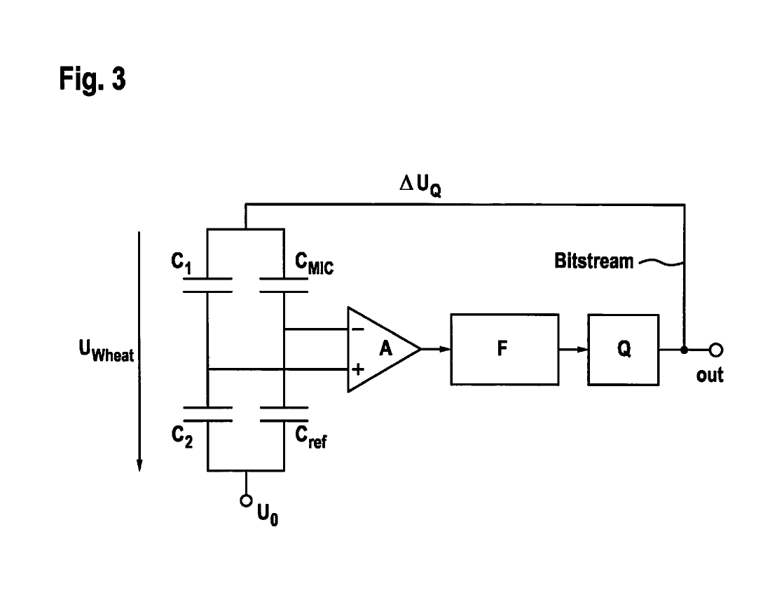

In the second exemplary embodiment shown in FIG. 3, microphone capacitor C_{MIC} is interconnected with a reference capacitance C_{ref} and two additional capacitances C₁ and C₂ in a Wheatstone bridge. This bridge circuit is fed from a separate fixed voltage source U₀, which delivers a voltage in the order of double the pull-in voltage. Reference capacitance C_{ref} and additional capacitances C₁ and C₂ are selected and interconnected in such a way that the output signal of the Wheatstone bridge corresponds to the deviation of the voltage present at microphone capacitor C_{MIC} from the corresponding pull-in voltage. In the simplest case, reference capacitance C_{ref} corresponds to the capacitance of microphone capacitor C_{MIC} when the pull-in voltage is applied and the two capacitances C₁ and C₂ are generally identical.

In this second exemplary embodiment, the base voltage present at microphone capacitor C_{MIC} is not regulated directly, but instead indirectly, in that the voltage present at the Wheatstone bridge is regulated as a function of its output signal. For this purpose, the output signal of the Wheatstone bridge is fed to an operational amplifier A. A filter F and a quantizer Q are connected downstream from it. This is advantageously a delta-sigma modulator for digitizing the output signal. The digitized output signal is fed back to the Wheatstone bridge, so that U_{Wheat}=U₀+ΔU_{Q}, ΔU_{Q} corresponding to the bit stream of quantizer Q. This causes voltage U_{Wheat} at the Wheatstone bridge to be regulated in such a way that the capacitance of microphone capacitor C_{MIC} corresponds to reference capacitance C_{ref}. This means that the potential difference at microphone capacitor C_{MIC} is regulated to the pull-in voltage via bit stream ΔU_{Q} of quantizer Q. For this purpose, the pulse density of bit stream ΔU_{Q} is adjusted in such a way that on average the voltage, which is required for the pull-in operation of microphone capacitor C_{MIC}, is generated.

Since the voltage contribution of bit stream ΔU_{Q} is very small compared to U₀ and also to the base voltage at microphone capacitor C_{MIC}, the regulation of the base voltage at microphone capacitor C_{MIC} takes place here also in a low-voltage range.

1-9. (canceled)

10. A method for regulating an electrical bias voltage at a measuring capacitor of a MEMS sensor element; comprising:
applying a base voltage to the measuring capacitor, and subsequently regulating the base voltage in such a way that a potential difference between both electrode sides of the measuring capacitor corresponds to a setpoint voltage, the regulation of the base voltage taking place in a low-voltage range;
applying a predefined and non-variable base potential in the order of the setpoint voltage to a first electrode side of the measuring capacitor; and
applying a regulatable counter-potential which is low in comparison to the base voltage to a second electrode side of the measuring capacitor, the counter-potential being regulated in such a way that the potential difference at the measuring capacitor corresponds to the setpoint voltage.

11. An arrangement for regulating an electrical bias voltage at a measuring capacitor of a MEMS sensor element, comprising:
a first voltage source which delivers a voltage in the order of a setpoint voltage and is connected to a first electrode side of the measuring capacitor as a predefined base potential;
a counter-potential which is low in comparison to the base potential and which is applied to the second electrode side of the measuring capacitor;
an operational amplifier, an inverting input of the operational amplifier being connected to the second electrode side of the measuring capacitor and an output of the operational amplifier is fed back to the inverting input via a defined capacitance;
a regulator connected downstream from the output of operational amplifier, the regulator having an output fed back to a non-inverting input of operational amplifier, so that a counter-potential present at the inverting input of the operational amplifier is regulated on the second electrode side of the measuring capacitor via an output signal of the regulator.

12. The regulating arrangement as recited in claim 11, wherein the regulator is an analog PI controller having a processing logic connected upstream and the PI controller includes at least one operational amplifier, which is fed back via a defined capacitance and a resistor, and a resistor being connected upstream from its inverting input.

13. A method of using of regulating arrangement, comprising:
providing a regulating arrangement, the regulating arrangement including a first voltage source which delivers a voltage in the order of a setpoint voltage and is connected to a first electrode side of the measuring capacitor as a predefined base potential, a counter-potential which is low in comparison to the base potential and which is applied to the second electrode side of the measuring capacitor, an operational amplifier, an inverting input of the operational amplifier being connected to the second electrode side of the measuring capacitor and an output of the operational amplifier is fed back to the inverting input via a defined capacitance, and a regulator connected downstream from the output of operational amplifier, the regulator having an output fed back to a non-inverting input of operational amplifier, so that a counter-potential present at the inverting input of the operational amplifier is regulated on the second electrode side of the measuring capacitor via an output signal of the regulator; and
one of: setting a pull-in voltage at the microphone capacitor of a microphone element as an electrical bias voltage using the regulating arrangement, or setting a pull-in voltage at the measuring capacitor of an acceleration sensor element as an electrical bias voltage using the regulating arrangement.
